(19) United States
(12) Patent Application Publication
(10) Pub. No.: US 2014/0123154 A1
(43) Pub. Date: May 1, 2014

(54) DATA PROCESSING METHOD AND DATA PROCESSING SYSTEM

(71) Applicant: Fujitsu Limited, Kawasaki-shi (JP)

(72) Inventors: Koichiro Yamashita, Hachioji (JP); Hiromasa Yamauchi, Usakos (NA); Takahisa Suzuki, Yokohama (JP); Koji Kurihara, Kawasaki (JP)

(73) Assignee: Fujitsu Limited, Kawasaki-shi (JP)

(21) Appl. No.: 14/148,288

(22) Filed: Jan. 6, 2014

Related U.S. Application Data
(63) Continuation of application No. PCT/JP2011/065519, filed on Jul. 6, 2011.

(51) Int. Cl. G06F 9/50; G06F 9/46

(52) U.S. Cl. CPC G06F 9/50; G06F 9/46
USPC 718/104; 718/102

(57) ABSTRACT

A data processing method that is executed by a data processing system includes determining whether an application whose startup is requested by a first data processing apparatus among a plurality of data processing apparatuses, belongs to a predetermined group; determining whether a second data processing apparatus among the data processing apparatuses has started up the application, when the application belongs to the predetermined group; and aborting startup of the application by the first data processing apparatus, when the second data processing apparatus has started up the application.

### CROSS REFERENCE TO RELATED APPLICATIONS

This application is a continuation application of International Application PCT/JP2011/065519, filed on Jul. 6, 2011 and designating the U.S., the entire contents of which are incorporated herein by reference.

### FIELD

The embodiments discussed herein are related to a data processing method and a data processing system.

### BACKGROUND

According to a conventional technique, distributed, parallel processing is executed by using plural nodes as a multi-processor that has distributed memory, where each node is a terminal such as a mobile telephone and a personal digital assistant (PDA). Operating an application using such a distributed memory computer enables achieving scalable performance of the application.

Terminals that include hardware such as a coprocessor, a digital signal processor (DSP), and a global positioning system (GPS) have appeared and as a result, various applications such as a graphic app, a multi-media app, and a map app can be operated on each terminal.

According to a related technique, for example, when the remaining amount of a resource of an electronic device becomes less than or equal to a predetermined amount during the execution of a job of the electronic device, the electronic device requests another electronic device to lend a resource thereof. According to another technique, an authentication process is executed using an electronic device between a borrower of a computing resource and a provider thereof; when validity is mutually recognized, an application for solving the problem is transmitted from the borrower to the provider; and the provider executes the application using the computing resource of the provider and transmits the result to the borrower. According to yet another technique, in a distributed system, it is determined whether resources detected from plural devices and necessary for a requested service each satisfies a resource publicizing policy; and the service is provided being linked to resources that satisfy the resource publicizing policy. For examples, refer to Japanese Laid-Open Patent Publication Nos. 2007-325235, 2005-50272, and 2004-199300.

However, according to the conventional techniques, a problem arises in that, in a system that includes plural data processing apparatuses (for example, terminals), when the data processing apparatuses each executes an application, insufficient consideration is given to the energy efficiency of the overall system.

### SUMMARY

According to an aspect of an embodiment, a data processing method that is executed by a data processing system includes determining whether an application whose startup is requested by a first data processing apparatus among a plurality of data processing apparatuses, belongs to a predetermined group; determining whether a second data processing apparatus among the data processing apparatuses has started up the application, when the application belongs to the predetermined group; and aborting startup of the application by the first data processing apparatus, when the second data processing apparatus has started up the application.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of a data processing method according to a first embodiment;

FIG. 2 is an explanatory diagram of an example of a system configuration of the data processing system according to a second embodiment;

FIG. 3 is an explanatory diagram of an example of a hardware configuration of a mobile terminal according to the second embodiment;

FIG. 4 is an explanatory diagram of an example of the contents of a shared resource table;

FIG. 5 is a block diagram of an example of a functional configuration of the mobile terminal according to the second embodiment;

FIG. 6 is an explanatory diagram of an example of the contents of a shared resource flag table;

FIG. 7 is an explanatory diagram of an example of the contents of the access permission table;

FIG. 8 is an explanatory diagram of an example of operational linking among mobile terminals;

FIG. 9 is a flowchart (Part I) of an example of a procedure for data processing by the mobile terminal according to the second embodiment;

FIG. 10 is a flowchart (Part II) of an example of a procedure for data processing by the mobile terminal according to the second embodiment;

FIG. 11 is a flowchart (Part I) of an example of a procedure for data processing by the mobile terminal according to the third embodiment;

FIG. 12 is a flowchart (Part II) of an example of a procedure for data processing by the mobile terminal according to the third embodiment; and

FIG. 13 is a diagram of an example of an application to a system using the computer of the present embodiments.

### DESCRIPTION OF EMBODIMENTS

Embodiments of a data processing method and a data processing system will be described in detail with reference to the accompanying drawings.

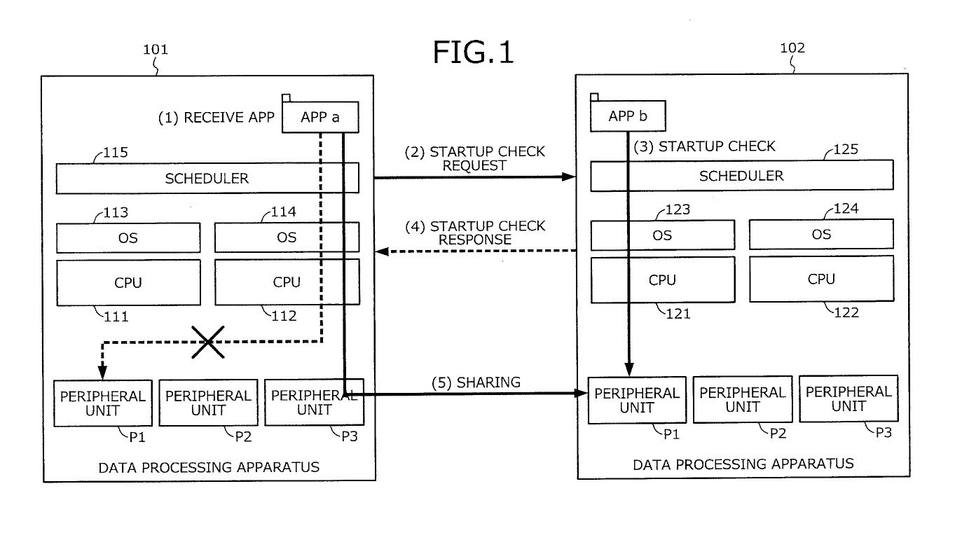

FIG. 1 is an explanatory diagram of an example of a data processing method according to a first embodiment. In FIG. 1, data processing apparatuses 101 and 102 are computers each capable of executing an application (hereinafter, also referred to as “app”). The data processing apparatuses 101 and 102 may be, for example, a mobile telephone, a PDA, a smartphone, a notebook personal computer (PC), a game device, a PC, a server, and the like.

The data processing apparatuses 101 and 102 each include at least one central processing unit (CPU) and at least one peripheral unit. In the example of FIG. 1, the data processing apparatus 101 includes CPUs 111 and 112, and peripheral units P1 to P3. The CPU 111 executes an operating system (OS) 113 and supervises the overall control of the data processing apparatus 101. The OS 113 includes a scheduler 115 that controls to which CPU an application is assigned. The CPU 111 executes an application assigned thereto. The CPU 112 executes an OS 114 and executes an application assigned to the OS 114.

The data processing apparatus 102 includes CPUs 121 and 122, and peripheral units P1 to P3. The CPU 121 executes an OS 123 and supervises the overall control of the data processing apparatus 102. The OS 123 includes a scheduler 125 that controls to which CPU an application is assigned. The CPU 121 executes an application assigned thereto. The CPU 122 executes an OS 124 and executes an application assigned to the OS 124.

The peripheral units P1 to P3 are hardware resources used for the execution of various types of applications and may be, for example, a coprocessor, a DSP, a GPS device, a camera device, a communication interface (I/F), an encryption circuit, and the like. In FIG. 1, the peripheral unit P1 of the data processing apparatus 101 and the peripheral unit P1 of the data processing apparatus 102 suffice to have substantially the same functions and, for example, may have processing performances that differ from one another. The same applies to each of the peripheral units P2 and P3.

For example, when an app such as a map app or a route search app is executed, a hardware resource such as the coprocessor or the GPS device is used. When a multi-media app is executed, a hardware resource such as the coprocessor or the DSP is used. When a graphic application is executed, a hardware resource such as the coprocessor is used. When a social networking service (SNS) app or a business app is executed, a hardware resource such as the encryption circuit is used.

When the data processing apparatuses 101 and 102 execute the same or different applications, using a hardware resource that is substantially same, the energy efficiency of the data processing apparatuses 101 and 102 may not be favorable overall.

For example, it is assumed that the data processing apparatuses 101 and 102 are located in the same area each execute an application using the GPS device. The “area” is any one of divided areas formed by partitioning a region on a map. In this case, coordinate data concerning each of the data processing apparatuses 101 and 102 located in the same area is substantially same. Therefore, it is not efficient for each of the data processing apparatuses 101 and 102 to independently operate the GPS device thereof and acquire the coordinate data thereof. When a hardware resource is started up, a predetermined amount of electric power is consumed regardless of the content of the process. Therefore, the power consumption increases in the overall system as the number of running hardware resources increases.

In the first embodiment, when the plural data processing apparatuses (for example, the data processing apparatuses 101 and 102) independently execute an application that uses a peripheral unit having substantially the same function, the peripheral unit started up first by any one of the data processing apparatuses is shared among the apparatuses. Thereby, the applications can be executed even when the data processing apparatuses do not respectively start up a peripheral unit thereof and therefore, power consumption is reduced in the overall system.

An example of a procedure for data processing by the data processing apparatuses 101 and 102 will be described. In the example, it is assumed that the data processing apparatus 102 executes an app b that uses the peripheral unit P1 and that the peripheral unit P3 is a “communication I/F”.

(1) The data processing apparatus 101 receives a startup request for an app “a”. For example, the scheduler 115 receives from the OS 113, the startup request for the app “a”. In this case, the app “a” is an application that is executed using the peripheral unit P1.

(2) The data processing apparatus 101 makes an inquiry to the data processing apparatus 102 and inquires whether at the data processing apparatus 102, the peripheral unit P1 that is used for the execution of the app “a” has been started up. For example, the scheduler 115 transmits to the data processing apparatus 102, a startup check request for the peripheral unit P1, through the communication I/F (the peripheral unit P3).

(3) When the data processing apparatus 102 receives the inquiry as to whether at the data processing apparatus 102, the peripheral unit P1 has been started up, the data processing apparatus 102 determines whether the peripheral unit P1 of the data processing apparatus 102 has been started up. For example, a scheduler 125 determines whether a flag is set indicating that the peripheral unit P1 has been started up.

(4) The data processing apparatus 102 transmits to the data processing apparatus 101, a startup check response that indicates whether at the data processing apparatus 102, the peripheral unit P1 has been started up. For example, the scheduler 125 transmits to the data processing apparatus 101, the startup check response for the peripheral unit P1, through the communication I/F (the peripheral unit P3).

In this case, the flag is set indicating that the peripheral unit P1 used for the execution of the app b has been started up, that is, that the peripheral unit P1 has been operating. Therefore, the data processing apparatus 102 transmits to the data processing apparatus 101, a startup check response indicating that the peripheral unit P1 has been started up. Thus, the data processing apparatus 101 receives the startup check response for the peripheral unit P1.

(5) If the peripheral unit P1 of the data processing apparatus 102 has been started up, the data processing apparatus 101 executes the app “a” using the peripheral unit P1 that has been started up by the data processing apparatus 102. The data processing apparatus 101 does not start up the peripheral unit P1 of the data processing apparatus 101 and uses the peripheral unit P1 that has been started up at the data processing apparatus 102, sharing the peripheral unit P1 with the data processing apparatus 102.

In (5), if the peripheral unit P1 of the data processing apparatus 102 has not been started up, the data processing apparatus 101 has to start up the peripheral unit P1 of the data processing apparatus 101 to execute the app “a”. In this case, a flag is set indicating that the peripheral unit P1 of the data processing apparatus 101 has been started up.

As described, according to the first embodiment, when the data processing apparatus 101 executes the app “a” that uses the peripheral unit P1, the data processing apparatus 101 can use the peripheral unit P1 already started up by the data processing apparatus 102. Thus, the data processing apparatus 101 can execute the app “a” even without starting up the peripheral unit P1 thereof, thereby enabling the power consumption to be reduced in the overall system.

A data processing system according to a second embodiment will be described. Portions identical to the portions described in the first embodiment will not again be described.

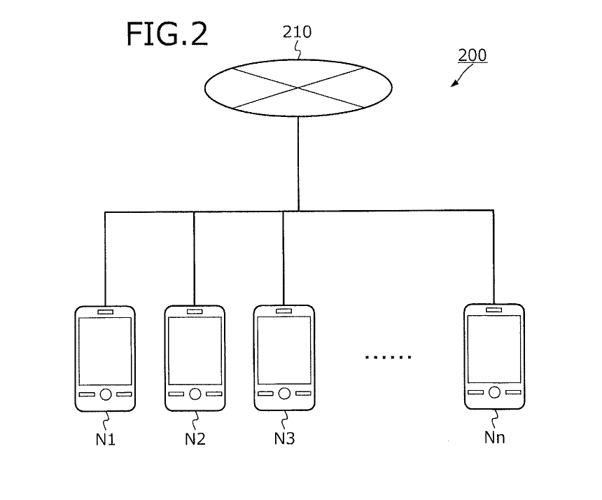

FIG. 2 is an explanatory diagram of an example of a system configuration of the data processing system according to the second embodiment. In FIG. 2, a data processing system 200 includes mobile terminals N1 to Nn (n: a natural number of two or larger). The mobile terminals N1 to Nn are computers such as, for example, a mobile telephone, a PDA, a smartphone, a notebook PC, and a game device, and correspond to the data processing apparatuses 101 and 102 depicted in FIG. 1.

In the data processing system 200, the mobile terminals N1 to Nn are connected to one another through a radio or wired network 210, enabling communication. The network 210 is, for example, an ad-hoc network, a local area network (LAN), a wide area network (WAN), or the Internet.

The ad-hoc network is a type of self-configuring network that is linked by radio communication. The ad-hoc network includes plural nodes (the mobile terminals N1 to Nn). The mobile terminals N1 to Nn in the ad-hoc network can communicate with the other mobile terminals via ad-hoc communication. The data processing system 200 may include a base station and a gateway.

An example of a hardware configuration of each of the mobile terminals N1 to Nn according to the second embodiment will be described. In the description below, an arbitrary mobile terminal among the mobile terminals N1 to Nn will be indicated as “mobile terminal Ni” (1=1, 2, . . . and n).

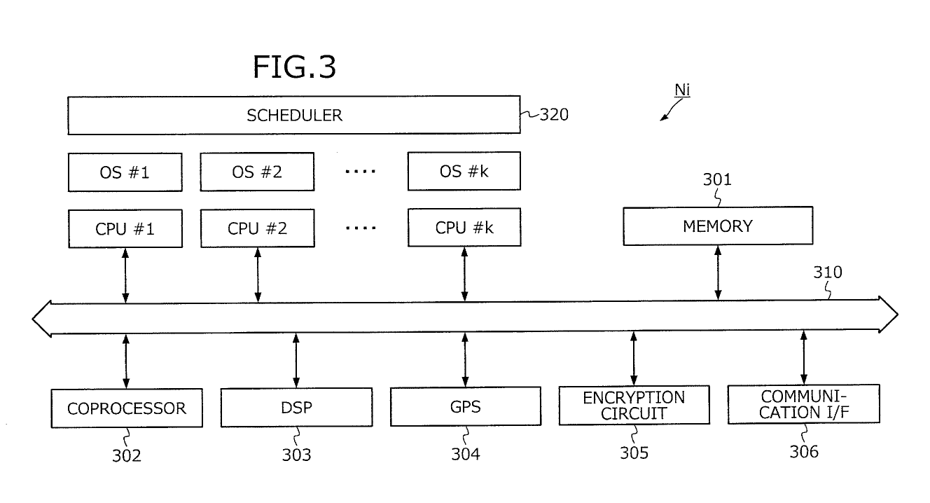

FIG. 3 is an explanatory diagram of an example of a hardware configuration of the mobile terminal according to the second embodiment. In FIG. 3, the mobile terminal Ni includes CPUs #1 to #k (k: a natural number that is one or larger), memory 301, a coprocessor 302, a DSP 303, a GPS 304, an encryption circuit 305, and a communication I/F 306.

In the mobile terminal Ni, the components from the CPUs #1 to #k to the communication I/F 306 are connected to each other through a bus 310. A portion of the software included in the mobile terminal Ni (OSs #1 to #k and a scheduler 320) is depicted in FIG. 3.

The CPU #1 executes the OS #1 and supervises the overall control of the mobile terminal Ni. The OS #1 is a master OS and includes the scheduler 320 that controls to which CPU an application is assigned. The CPU #1 executes an application assigned thereto. The CPUs #2 to #k respectively execute the OSs #2 to #k and applications assigned to the OS #2 to #k. The OSs #2 to #k are slave OSs.

The memory 301 is memory shared among the CPUs #1 to #k and includes, for example, read only memory (ROM), random access memory (RAM), and flash ROM.

For example, the flash ROM stores each of the OS programs; the ROM stores application programs; and the RAM is used as a work area of the CPUs #1 to #k. Programs stored in the memory 301 are loaded onto the CPUs, causing the CPU to execute processes coded in the program.

The coprocessor 302 is a sub processing apparatus that assists the CPUs #1 to #k, and may be, for example, a floating point number processing unit (FPU), a graphics processing unit (GPU), and the like.

The DSP 303 is a micro processor that specializes in processing sounds, images, etc. The GPS 304 is a device that receives a radio signal from a GPS satellite and that outputs position information indicating the position of the mobile terminal Ni. Position information concerning the mobile terminal Ni is coordinate data that identifies one point on Earth such as, for example, the latitude and the longitude, the altitude, etc.

The encryption circuit 305 is a circuit that encrypts data. The communication I/F 306 is connected to the network 210 through a communication line; is connected to external apparatuses through the network 210; supervises an interface between the network 210 and internal components; and controls the input and the output of data with respect to external apparatuses.

Although not depicted, the mobile terminal Ni may include a display, a keyboard, etc., in addition to, for example, a memory controller that controls the reading and the writing of data with respect to the memory 301, and a power management unit (PMU) that supplies power source voltage to the components.

The description above has been made assuming that each of the mobile terminals N1 to Nn has the same hardware configuration. However, the hardware configuration is not limited hereto. For example, the mobile terminal Ni may include peripheral units that are different from the above peripheral units (denoted by the reference numerals 301 to 306) or may omit some of the above peripheral units.

A shared resource table 400 used by the mobile terminal Ni will be described. The peripheral units used for the execution of an application include some peripheral units that are preferably not to be shared among the plural mobile terminals. For example, the encryption circuit 305 depicted in FIG. 3 is preferably not to be shared among the plural mobile terminals from the viewpoint of the security. The shared resource table 400 is information that indicates each peripheral unit that is permitted to be shared among the plural mobile terminals, among the peripheral units used for execution of applications.

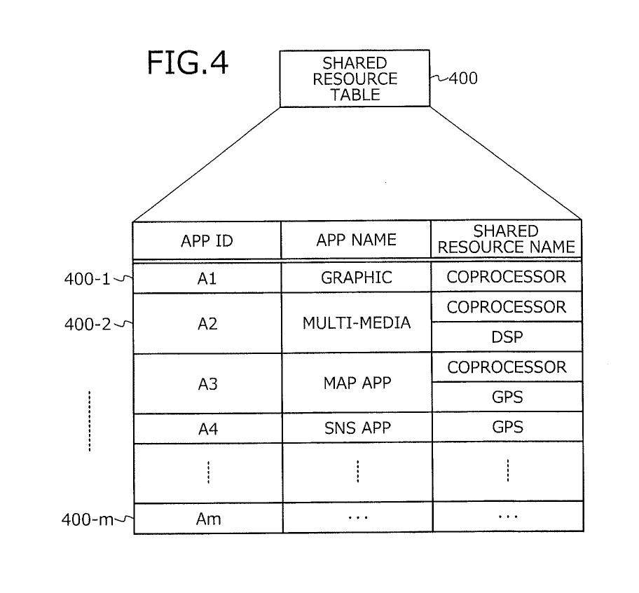

FIG. 4 is an explanatory diagram of an example of the contents of the shared resource table. In FIG. 4, the shared resource table 400 includes fields for the app ID, the app name, and the shared resource name. Shared resource information is stored as records 400-1 to 400-n, respectively for applications A1 to Am by setting information in each of the fields of the shared resource table 400.

The app ID is an identifier used herein of an application. The app name is the name of the application. The shared resource name is the name of a peripheral unit that among the peripheral units used for the execution of the applications, is permitted to be shared by plural mobile terminals.

Taking the shared resource information record 400-1 as an example, names are indicated such as the app name “graphic” of an application A1 and the shared resource name “coprocessor” of a resource that can be shared among the plural mobile terminals for the execution of the application A1.

Taking the shared resource information record 400-2 as an example, names are indicated such as the app name “multimedia” of an application A2 and the shared resource names “coprocessor, DSP” of resources that can be shared among the plural mobile terminals for the execution of the application A1.

The shared resource table 400 is stored in, for example, the memory 301 depicted in FIG. 3. For example, the shared resource information records 400-1 to 400-m respectively concerning the applications A1 to Am are stored in a file system of the mobile terminal Ni together with execution objects of the applications A1 to Am. The shared resource table 400 is produced by, for example, referring to a make file of each application and comparing the peripheral units that can be shared among the plural mobile terminals, with the peripheral units included in the mobile terminal N when the application is compiled.

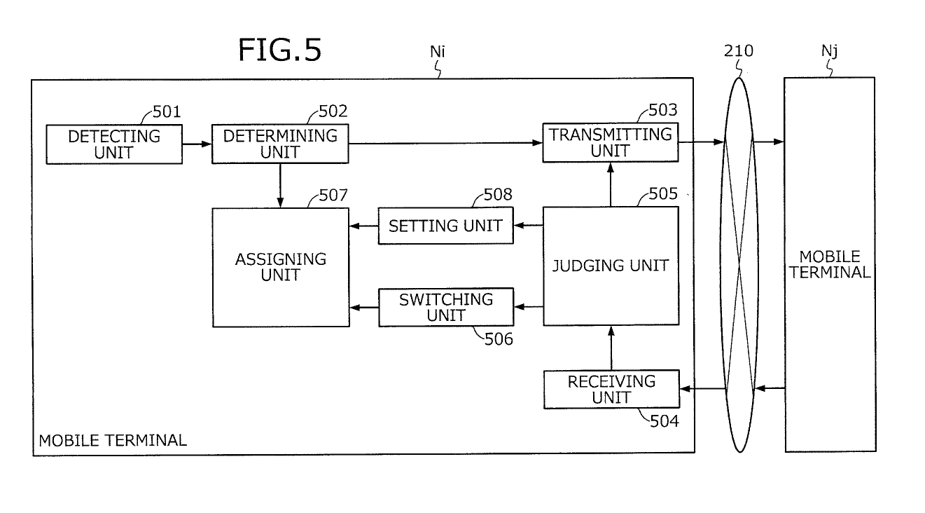

FIG. 5 is a block diagram of an example of a functional configuration of the mobile terminal according to the second embodiment. As depicted in FIG. 5, the mobile terminal Ni includes a detecting unit 501, a determining unit 502, a transmitting unit 503, a receiving unit 504, a judging unit 505, a switching unit 506, an assigning unit 507, and a setting unit 508. These functions (the detecting unit 501 to the setting unit 508) forming a control unit are implemented by, for example, causing the CPU #1 to execute the programs stored in the memory 301 depicted in FIG. 3 or using the communication I/F 306. The result of the processing by each of the functional units is stored in the memory 301.

The functional units of the mobile terminal Ni will be described first for a case where the mobile terminal Ni (hereinafter, referred to as “client”) requests another mobile terminal Nj (j≠i and j=1, 2, . . . , and n) for use of a shared resource.

The detecting unit 501 detects a startup request for an application. For example, the scheduler 320 detects the startup request for the application from the OS #1. In the description below, the application for which the startup request is detected will be indicated as “app A”.

When the startup request for the app A is detected, the determining unit 502 determines whether a shared resource P is used for the execution of the app A. The “shared resource P” is a peripheral unit that is permitted to be shared among plural mobile terminals, that is, a peripheral unit whose sharing is permitted among plural mobile terminals.

For example, the scheduler 320 refers to the shared resource table 400 depicted in FIG. 4, and determines whether a shared resource P is used to execute the app A. For example, it is assumed that the app A is “the application A1”. In this case, the scheduler 320 refers to the shared resource table 400 and determines that “the coprocessor 302” is used as a shared resource P to execute the application A1. For example, it is assumed that the app A is “an application A3”. In this case, the scheduler 320 refers to the shared resource table 400 and determines that “the coprocessor 302 and the GPS 304” are used as shared resources P to execute the application A3.

If it is determined that a shared resource P is used to execute the app A, the transmitting unit 503 transmits to another mobile terminal Nj, a startup check request for the shared resource P. The “startup check request for the shared resource P” is information to ask the other mobile terminal Nj whether at the other mobile terminal Nj, the shared resource P has been started up.

For example, the scheduler 320 controls the communication I/F 306 and broadcasts the startup check request for the shared resource P to the network 210 using ad-hoc communication. For example, it is assumed that the app A is “the application A1”. In this case, the scheduler 320 broadcasts the startup check request for the coprocessor 302 that is the shared resource P.

When plural shared resources P are to be used for the execution of the app A, the scheduler 320 broadcasts the startup check request for each of the shared resources P. For example, it is assumed that the app A is “the application A3”. In this case, the scheduler 320 may separately broadcast each of the startup check requests for the coprocessor 302 and the GPS 304 that are the shared resources P, or may collectively broadcast the startup check requests for the coprocessor 302 and the GPS 304.

As the result of the transmission of the startup check requests for the shared resource P, the receiving unit 504 receives a startup check response for the shared resource P, from the other mobile terminal Nj. The “startup check response for the shared resource P” is information indicating whether the shared resource P is started up. For example, the scheduler 320 receives the startup check response for the shared resource P from the other mobile terminal Nj through the communication I/F 306.

The judging unit 505 judges based on the received startup check response for the shared resource P, whether at the other mobile terminal Nj, the shared resource P used to execute the app A has been started up. For example, if the scheduler 320 receives from the other mobile terminal Nj, a startup check response indicating that the shared resource P at the other mobile terminal Nj has been started up, the scheduler 320 judges that the shared resource P at the other mobile terminal Nj has been started up.

On the other hand, if the scheduler 320 does not receive a startup check response indicating that the shared resource P has been started up even after a specific time period elapses from the transmission of the startup check request for the shared resource P, the scheduler 320 may judge that the shared resource P at the other mobile terminal Nj has not been started up. Before the specific time period elapses, if the scheduler 320 receives from each of the mobile terminals other than the mobile terminal Ni among the mobile terminals N1 to Nn, a startup check response indicating that the shared resource P has not been started up, the scheduler 320 judges that the other mobile terminal Nj has not started up the shared resource P.

If the judging unit 505 judges that the shared resource P of the other mobile terminal Nj has been started up, the switching unit 506 switches a device driver for the shared resource P from a real device driver to a virtual device driver. The “real device driver” is software to operate the shared resource P of the mobile terminal Ni. The “virtual device driver” is software to implement the function of the shared resource P using the shared resource P currently started up by the other mobile terminal Nj by communicating with the other mobile terminal Nj through the network 210.

For example, when the other mobile terminal Nj has started up the shared resource P, the scheduler 320 switches the device driver to be correlated with a driver application program interface (API) of the shared resource P from the real device driver to the virtual device driver. In the initial state, the driver API of the shared resource P is correlated with the real device driver of the shared resource P. For example, the scheduler 320 unloads the real device driver of the shared resource P and thereafter, loads the virtual device driver of the shared resource P.

When the virtual device driver of the shared resource P is correlated with the driver API of the shared resource P, the scheduler 320 sets in the virtual device driver, identification information concerning the other mobile terminal Nj at which the shared resource P has been started up. For example, the address of the other mobile terminal Nj may be used as the identification information concerning the other mobile terminal Nj. Thus, the other mobile terminal Nj at which the shared resource P to be used to execute the app A has been started up can be identified.

A case is present where the shared resources P at other mobile terminals are currently started up in plural. In this case, the scheduler 320 may set in the virtual device driver, identification information concerning the other mobile terminal that transmitted the startup check response earliest among the other mobile terminals at which the shared resource P has been started up.

The scheduler 320 may set in the virtual device driver, identification information concerning the other mobile terminal whose load on the shared resource P is the lowest among the other mobile terminals at which the shared resource P has been started up. The “load on the shared resource P” is, for example, the use rate of the shared resource P.

Load information used to identify the load on the shared resource P at each of the other mobile terminals is, for example, included in the startup check response indicating that the shared resource P has been started up. As described, if the shared resources P at other mobile terminals are currently started up, the shared resource P whose load is relatively low is selected and shared and thereby, a backlog of the processing by the shared resource P can be avoided.

When the switching unit 506 switches the device driver of the shared resource P to the virtual device driver, the switching unit 506 sets a switching flag for the shared resource P from “0” to “1”. The “switching flag for the shared resource P” is information to identify the device driver correlated with the driver API of the shared resource P.

If the switching flag indicates “0”, this indicates that the real device driver is correlated with the driver API of the shared resource P. On the other hand, if the switching flag indicates “1”, this indicates that the virtual device driver is correlated with the driver API of the shared resource P. In the initial state, the switching flag of the shared resource P indicates “0”.

As a result of the switching of the device driver of the shared resource P to the virtual device driver, the assigning unit 507 assigns the app A to any one of CPUs #1 to #k. For example, based on the load information concerning the CPUs #1 to #k, the scheduler 320 selects a CPU to be the assignment destination of the app A from among the CPUs #1 to #k and assigns the app A to the selected CPU.

As a result, the OS of the assignment destination CPU executes the app A. In this case, the device driver of the shared resource P has been switched to the virtual device driver and therefore, the app A is executed using the shared resource P currently started up at the other mobile terminal Nj. Thereby, the app A can be executed without starting up the shared resource P of the mobile terminal Ni.

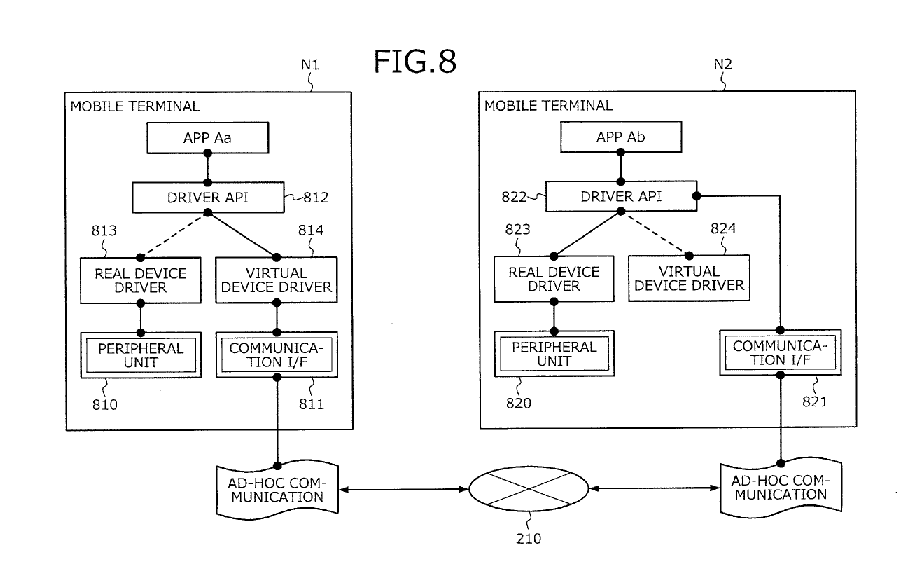

An example of operational linking among the mobile terminals when the shared resource P is shared among the plural mobile terminals will be described later with reference to FIG. 8.

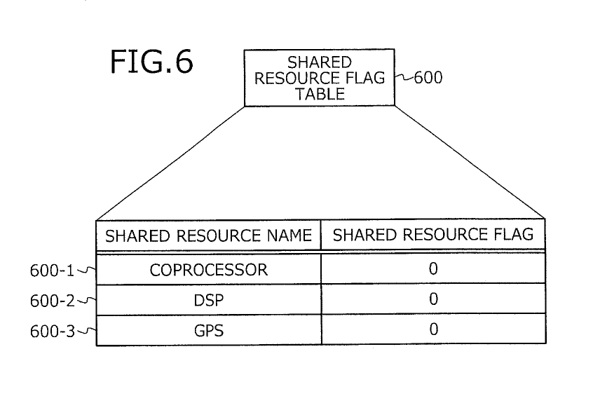

If the judging unit 505 judges that the other mobile terminal Nj has not started up the shared resource P, the setting unit 508 sets a flag indicating that the shared resource P has been started up. For example, in a shared resource flag table 600 depicted in FIG. 6, the scheduler 320 may set the flag indicating that the shared resource P has been started up.

The shared resource flag table 600 will be described. The shared resource flag table 600 is implemented by, for example, the memory 301.

FIG. 6 is an explanatory diagram of an example of the contents of the shared resource flag table. In FIG. 6, the shared resource flag table 600 includes fields for the shared resource name and the shared resource flag. Flag information indicating whether a shared resource has been started up is stored in the shared resource flag table 600 as records 600-1 to 600-3 by setting information in each of the fields.

The “shared resource name” is the name of a shared resource. This shared resource is, for example, a peripheral unit registered in the shared resource table 400 depicted in FIG. 4. The shared resource flag is a flag indicating whether the shared resource has been started up. If the shared resource flag indicates “0”, this indicates that the shared resource has not been started up. On the other hand, if the shared resource flag indicates “1”, this indicates that the shared resource has been started up. In the initial state, the shared resource flag indicates “0”.

For example, if the judging unit 505 judges that the other mobile terminal Nj has not started up “the coprocessor 302” that is the shared resource P, in the shared resource flag table 600, the scheduler 320 changes the shared resource flag of the flag information record 600-1 from “0” to “1”.

Returning back to the description with reference to FIG. 5, if the judging unit 505 judges that the other mobile terminal Nj has not started up the shared resource P, the assigning unit 507 assigns the app A to any one of the CPUs #1 to #k. As a result, the OS of the assignment destination CPU executes the app A. In this case, the device driver of the shared resource P is the real device driver and therefore, the OS executes the app A using the shared resource P of the mobile terminal Ni.

The process of setting the flag indicating that the shared resource P has been started up, executed by the setting unit 508, may be executed after the app A is assigned to any one of the CPUs.

If the determining unit 502 determines that a shared resource P is not used for the execution of the app A, the assigning unit 507 assigns the app A to any one of the CPUs #1 to #k. As a result, the OS of the assignment destination CPU executes the app A. No peripheral unit that can be shared with the other mobile terminal Nj is included among the peripheral units used for the execution of the app A and therefore, the app A is executed using the peripheral unit of the mobile terminal Ni.

Functional units of the mobile terminal Ni will be described for a case where the mobile terminal Ni (hereinafter, referred to as “server”) is requested by the other mobile terminal Nj for use of the shared resource P.

The receiving unit 504 receives a startup check request for a shared resource P from the mobile terminal Nj. The “shared resource P” is a shared resource that is to be used for the execution of the app A for which the startup request has been detected by the other mobile terminal Nj. For example, the scheduler 320 receives the startup check request for the shared resource P from the other mobile terminal Nj, via the network 210.

When the scheduler 320 receives the startup check request for the shared resource P, the judging unit 505 judges whether the shared resource P has been started up at the mobile terminal Ni. For example, by referring to the shared resource flag table 600 depicted in FIG. 6, the scheduler 320 may judge whether the mobile terminal Ni has started up the shared resource P.

For example, it is assumed that a startup check request is received for “the coprocessor 302”, which is the shared resource P. In this case, the scheduler 320 identifies from the shared resource flag table 600, the flag information record 600-1 concerning the coprocessor 302. If “1” is set in the shared resource flag of the flag information record 600-1, the scheduler 320 judges that the coprocessor 302 has been started up. On the other hand, if “0” is set in the shared resource flag of the flag information record 600-1, the scheduler 320 judges that the coprocessor 302 has not been started up.

The transmitting unit 503 transmits to the other mobile terminal Nj, a startup check response for the shared resource P. For example, if the judging unit 505 judges that the mobile terminal Ni has not started up the shared resource P, the scheduler 320 controls the communication I/F 306 and transmits to the other mobile terminal Nj that is the request source using the ad-hoc communication, a startup check response indicating that the mobile terminal Ni has not started up the shared resource P. On the other hand, if the judging unit 505 judges that the shared resource P has been started up at the mobile terminal Ni, the scheduler 320 controls the communication I/F 306 and transmits to the other mobile terminal Nj that is the request source using the ad-hoc communication, a startup check response indicating that the shared resource P at the mobile terminal Ni has been started up.

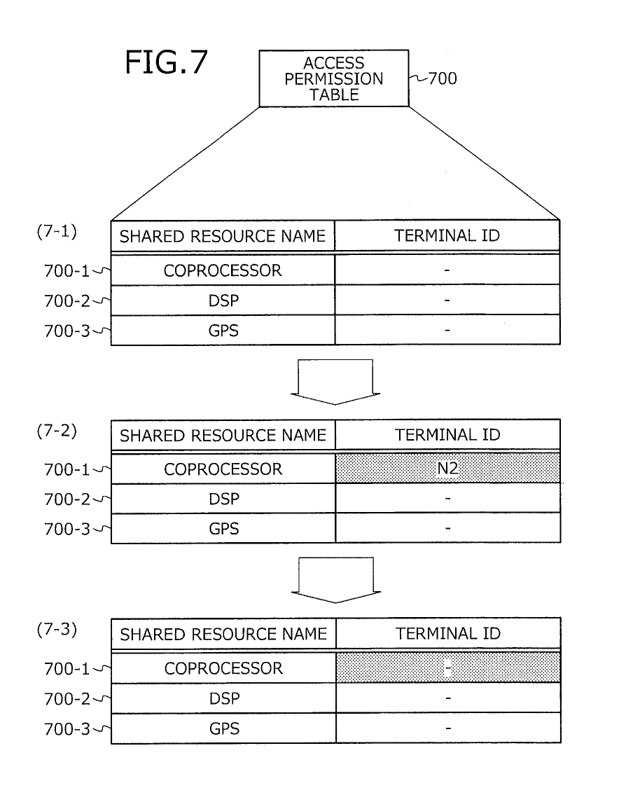

If the judging unit 505 judges that the shared resource P at the mobile terminal Ni has been started up, the setting unit 508 sets access permission for access of the shared resource P by the other mobile terminal Nj. For example, the scheduler 320 may set in an access permission table 700 depicted in FIG. 7, access permission for access of the shared resource P by the other mobile terminal Nj that is the request source.

The access permission table 700 will be described. The access permission table 700 is implemented by, for example, the memory 301.

FIG. 7 is an explanatory diagram of an example of the contents of the access permission table. In FIG. 7, the access permission table 700 includes fields for the shared resource name and the terminal ID. Access permission information for shared resources is stored in the access permission table 700 as records 700-1 to 700-3 by setting information in each of the fields.

The “shared resource name” is the name of a shared resource. This shared resource is, for example, a peripheral unit registered in the shared resource table 400 depicted in FIG. 4. The “terminal ID” is identification information concerning the other mobile terminal Nj for which access of the shared resource is permitted. The address of the other mobile terminal Nj can be used as the terminal ID.

An example will be described assuming that the mobile terminal Ni is a mobile terminal N1 that receives a startup check request for “the coprocessor 302” from a mobile terminal N2. In this case, if the coprocessor 302 has been started up, the scheduler 320 sets the terminal ID “N2” of the mobile terminal N2 in the terminal ID field of the access permission information record 700-1 in the access permission table 700 (see (7-2) in FIG. 7).

Thereafter, if the mobile terminal N2 requests access of the coprocessor 302 of the mobile terminal N1, the mobile terminal N1 permits access of the coprocessor 302. On the other hand, if another mobile terminal Nj whose terminal ID is not set in the terminal ID field of the access permission information record 700-1 requests access of the coprocessor 302, the mobile terminal N1 does not permit access of the coprocessor 302.

Thereby, the shared resource P currently started up by the mobile terminal N1 can be shared with a client, and any unauthorized access of the shared resource P by another mobile terminal other than the client can be prevented.

Returning back to the description with reference to FIG. 5, the judging unit 505 judges whether the operation of the shared resource P has come to an end. For example, when the execution of the application by the mobile terminal N1 using the shared resource P comes to an end, the scheduler 320 may judge that the operation of the shared resource P has come to an end.

If the judging unit 505 judges that the operation of the shared resource P has come to an end, the setting unit 508 sets a flag indicating that the shared resource P has not been started up. For example, the scheduler 320 may set the flag indicating that the shared resource P has not been started up, in the shared resource flag table 600.

For example, if the judging unit 505 judges that the operation of “the coprocessor 302”, which is the shared resource P, has come to an end, the scheduler 320 changes the shared resource flag of the flag information record 600-1 in the shared resource flag table 600 from “1” to “0”.

If the judging unit 505 judges that the operation of the shared resource P has come to an end, the setting unit 508 cancels the access permission for access of the shared resource P by the other mobile terminal Nj (that is, prohibits any access). For example, in the access permission table 700, the scheduler 320 may cancel the access permission for access of the shared resource P by the other mobile terminal Nj.

For example, in (7-2) depicted in FIG. 7, when the operation of the coprocessor 302 has come to an end, the scheduler 320 deletes from the terminal ID field of the access permission information 700-1 in the access permission table 700, the terminal ID “N2” of the mobile terminal N2 (see (7-3) in FIG. 7). Thereby, any unauthorized access of the shared resource P by another mobile terminal Nj can be prevented.

When communication is disconnected with the client with which the shared resource currently started up by the mobile terminal N1 is shared, the setting unit 508 may cancel the access permission for access of the shared resource P by the client. A case where “the communication with the client is disconnected” may be, for example, a case where a session established with the client is disconnected or where the signal strength of the communication with the client becomes less than or equal to a predetermined value.

The judging unit 505 may judge if the load on the shared resource P is greater than or equal to a predetermined value X, based on the load information concerning the shared resource P currently started up at the mobile terminal N1. The “predetermined value X” is set to be, for example, a value such that when the load on the shared resource P is greater than or equal to the predetermined value X, a backlog of the processing by the shared resource P occurs. The predetermined value X is, for example, set in advance and stored in the memory 301.

If the judging unit 505 judges that the load on the shared resource P is greater than or equal to the predetermined value X, the setting unit 508 may cancel the access permission for access of the shared resource P by the other mobile terminal Nj. Thereby, the occurrence of a backlog of the processing by the shared resource P can be prevented.

If the load on the shared resource P currently started up at the mobile terminal N1 is greater than or equal to the predetermined value X at the time point at which the startup check request for the shared resource P is received, the transmitting unit 503 may transmit to the other mobile terminal Nj that is the request source, a startup check response indicating that the shared resource P has not been started up. Thereby, the occurrence of a backlog of the processing by the shared resource P can be prevented in advance.

If the judging unit 505 judges that the shared resource P has been started up, the transmitting unit 503 may transmit to the other mobile terminal Nj that is the request source, a startup check response that includes load information concerning the shared resource P. Thereby, as described above, when the shared resources P at the plural mobile terminals are currently start up, the client can select and share the shared resource P whose load is relatively low, and the occurrence of a backlog of the processing by the shared resource P can be avoided.

An example of operational linking among the mobile terminals formed when the plural mobile terminals share the shared resource P will be described. FIG. 8 is an explanatory diagram of the example of the operational linking among the mobile terminals. In FIG. 8, the mobile terminal N1 is a client mobile terminal and includes a peripheral unit 810 and a communication I/F 811. The mobile terminal N2 is a mobile terminal server and includes a peripheral unit 820 and a communication I/F 821.

The communication I/Fs 811 and 821 each correspond to the communication I/F 306 depicted in FIG. 3. The peripheral units 810 and 820 are each the shared resource P having substantially the same function, and each corresponds to, for example, the coprocessor 302, the DSP 303, or the GPS 304 depicted in FIG. 3.

An app “Aa” is an application that is to be executed using the peripheral unit 810 that is the shared resource P. An app “Ab” is an application that is to be executed using the peripheral unit 820 that is the shared resource P.

A driver API 812, a real device driver 813, and a virtual device driver 814 are programs related to the peripheral unit 810 and are included in the OS of the mobile terminal N1. A driver API 822, a real device driver 823, and a virtual device driver 824 are programs related to the peripheral unit 820 and are included in the OS of the mobile terminal N2.

The client mobile terminal N1 detects a startup request for the app Aa and as a result, the driver API 812 of the peripheral unit 810 and the virtual device driver 814 are correlated with each other. On the other hand, in the mobile terminal server N2, the driver API 822 of the peripheral unit 820 and the real device driver 823 are correlated with each other, and the app Ab is executed using the peripheral unit 820.

An example of operational linking between the mobile terminals N1 and N2 will be described for a case where the mobile terminal N1 executes the app Aa using the peripheral unit 820 that has been started up by the mobile terminal N2.

The app Aa delivers an argument of a function to the virtual device driver 814 through the driver API 812 of the peripheral unit 810. Thereafter, the virtual device driver 814 transmits the argument of the function (including the name of the function) to the real device driver 823 of the peripheral unit 820 of the mobile terminal N2, through the communication I/F 811 by ad-hoc communication.

As a result, the real device driver 823 receives, through the driver API 822, the argument of the function that was received via the communication I/F 821. The real device driver 823 delivers the argument of the function to the peripheral unit 820 and thereby, acquires a return value of the function.

The real device driver 823 transmits the return value of the function to the virtual device driver 814 of the peripheral unit 810 of the mobile terminal N1, through the communication I/F 821 by ad-hoc communication. As a result, the virtual device driver 814 receives the return value of the function received by the communication I/F 811 and delivers the received return value to the app Aa.

Thereby, the mobile terminal N1 can execute the app Aa without starting up the peripheral unit 810, and the energy efficiency can be improved for the mobile terminals N1 and N2 overall.

A procedure for data processing by the mobile terminal Ni according to the second embodiment will be described. A procedure for the data processing by the client mobile terminal Ni will first be described.

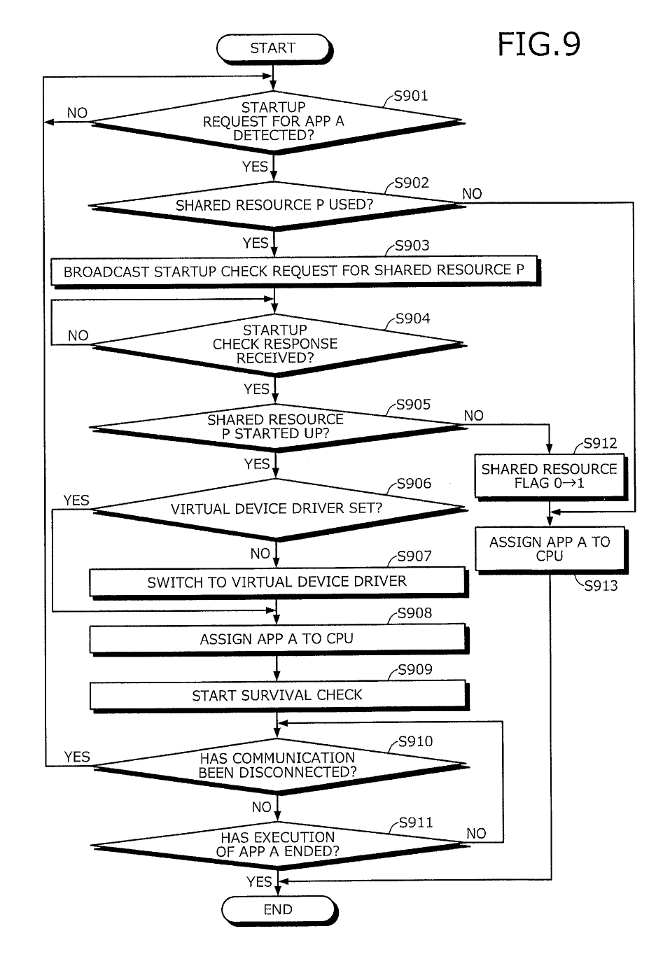

FIG. 9 is a flowchart (Part I) of an example of a procedure for data processing by the mobile terminal according to the second embodiment. In the flowchart of FIG. 9, the scheduler 320 determines whether a startup request for the app A has been detected (step S901).

The scheduler 320 waits for a startup request for the app A to be detected (step S901: NO). When the scheduler 320 determines that a startup request for the app A has been detected (step S901: YES), the scheduler 320 refers to the shared resource table 400 and determines whether the shared resource P is used for the execution of the app A (step S902).

If the scheduler 320 determines that the shared resource P is not used (step S902: NO), the procedure progresses to step S913. On the other hand, if the scheduler 320 determines that the shared resource P is used (step S902: YES), the scheduler 320 broadcasts the startup check request to the network 210 (step S903).

The scheduler 320 determines whether a startup check response for the shared resource P has been received from the other mobile terminal Nj (step S904). The scheduler 320 waits for the startup check response for the shared resource P to be received thereby (step S904: NO). When the scheduler 320 determines that a startup check response for the shared resource P has been received (step S904: YES), the scheduler 320 determines whether the other mobile terminal Nj has started up the shared resource P (step S905).

If the scheduler 320 determines that the other mobile terminal Nj has started up the shared resource P (step S905: YES), the scheduler 320 refers to the switching flag for the shared resource P and determines whether the virtual device driver is set in the shared resource P (step S906).

If the scheduler 320 determines that the virtual device driver is set in the shared resource P (step S906: YES), the procedure progresses to step S908. On the other hand, if the scheduler 320 determines that the virtual device driver is not set in the shared resource P (step S906: NO), the scheduler 320 switches the device driver of the shared resource P from the real device driver to the virtual device driver (step S907).

The scheduler 320 assigns the app A to any one among the CPUs #1 to #k (step S908) and starts a survival check to determine whether the state of the connection is being maintained with the other mobile terminal Nj (hereinafter, simply referred to as “server”) that has started up the shared resource P (step S909).

Thereafter, the scheduler 320 determines whether the communication with the server has been disconnected (step S910). If the scheduler 320 determines that the communication with the server has been disconnected (step S910: YES), the procedure returns to step S901 and the series of process steps are repeated. On the other hand, if the scheduler 320 determines that the communication with the server has not been disconnected (step S910: NO), the scheduler 320 determines whether the execution of the app A has come to an end (step S911).

If the scheduler 320 determines that the execution of the app A has not come to an end (step S911: NO), the procedure returns to step S910. On the other hand, if the scheduler 320 determines that the execution of the app A has come to an end (step S911: YES), the series of process steps according to this flowchart comes to an end.

If the scheduler 320 determines at step S905 that the other mobile terminal Nj has not started up the shared resource P (step S905: NO), the scheduler 320 changes the shared resource flag for the shared resource P in the shared resource flag table 600 from “0” to “1” (step S912) and assigns the app A to any one of the CPUs #1 to #k (step S913), and the series of process steps according to this flowchart come to an end.

Thus, when the app A using the shared resource P is executed, the app A can be executed using the shared resource P currently started up by the other mobile terminal Nj.

A procedure for data processing by the mobile terminal server Ni will be described.

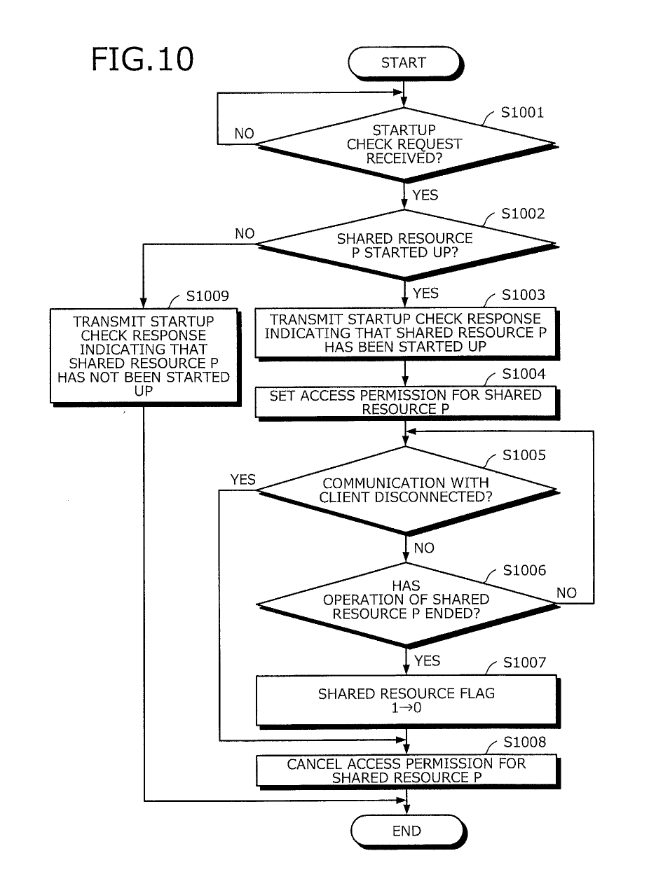

FIG. 10 is a flowchart (Part II) of an example of a procedure for data processing by the mobile terminal according to the second embodiment. In the flowchart of FIG. 10, the scheduler 320 determines whether a startup check request for the shared resource P has been received from the other mobile terminal Nj (step S1001).

The scheduler 320 waits for a startup check request for the shared resource P to be received (step S1001: NO). When the scheduler 320 determines that a startup check request for the shared resource P has been received (step S1001: YES), the scheduler 320 refers to the shared resource flag table 600 and determines whether the mobile terminal Ni has started up the shared resource P (step S1002).

If the scheduler 320 determines that the mobile terminal Ni has started up the shared resource P (step S1002: YES), the scheduler 320 transmits to the other mobile terminal Nj that is the request source (hereinafter, simply referred to as “client”), a startup check response indicating that the shared resource P has been started up (step S1003).

The scheduler 320 sets in the access permission table 700, the access permission for access of the shared resource P by the client (step S1004) and determines whether communication with the client has been disconnected (step S1005).

If the scheduler 320 determines that communication with the client has not been disconnected (step S1005: NO), the scheduler 320 determines whether the operation of the shared resource P by the mobile terminal Ni has come to an end (step S1006). If the scheduler 320 determines that the operation of the shared resource P has not come to an end (step S1006: NO), the procedure returns to step S1005.

On the other hand, if the scheduler 320 determines that the operation of the shared resource P has come to an end (step S1006: YES), the scheduler 320 changes the shared resource flag for the shared resource P in the shared resource flag table 600 from “1” to “0” (step S1007). The scheduler 320 cancels the access permission for access of the shared resource P by the client (step S1008) and the series of process steps according to this flowchart comes to an end.

At step S1002, if the scheduler 320 determines that the mobile terminal Ni has not started up the shared resource P (step S1002: NO), the scheduler 320 transmits to the client, a startup check response indicating that the shared resource P has not been started up (step S1009) and the series of process steps according to this flowchart comes to an end.

If the scheduler 320 determines at step S1005 that communication with the client has been disconnected (step S1005: YES), the scheduler 320 cancels the access permission for access of the shared resource P by the client (step S1008) and the series of process steps according this flowchart comes to an end.

Thus, the shared resource P started up by the mobile terminal Ni can be shared with the other mobile terminal Nj.

As described, according to the mobile terminal Ni of the second embodiment, when the app A that uses the shared resource P is executed, the shared resource P that is already started up by the other mobile terminal Nj can be used through the network 210. Thereby, the app A can be executed without starting up the shared resource P by the mobile terminal Ni, and power consumption can be reduced in the overall system.

According to the mobile terminal Ni of the second embodiment, the startup check response indicating whether the shared resource P has been started up can be transmitted to the request source in response to the startup check request for the shared resource P from the other mobile terminal Nj. Thereby, the shared resource P currently started up by the mobile terminal Ni can be shared among the plural mobile terminals.

According to the mobile terminal Ni of the second embodiment, access permission for access of the shared resource P currently started up by the mobile terminal Ni can be set exclusively for the other mobile terminal Nj that is the request source of the startup check request for the shared resource P. Thereby, any unauthorized access of the shared resource P by the other mobile terminals other than the client can be prevented.

According to the mobile terminal Ni of the second embodiment, when the operation of the shared resource P by the mobile terminal Ni comes to an end, or when the communication with the client is disconnected, access permission for access of the shared resource P by the client can be cancelled.

According to the mobile terminal Ni of the second embodiment, when the load on the shared resource P currently operating for the mobile terminal Ni becomes greater than or equal to the predetermined value X, access permission for access of the shared resource P by the other mobile terminal Nj can be cancelled. Thereby, the occurrence of a backlog of the processing by the shared resource P can be prevented.

According to the mobile terminal Ni of the second embodiment, when plural mobile terminals each starts up a shared resource P, the shared resource P whose load is relatively low is selected and used, whereby the occurrence of a backlog of the processing by the shared resource P can be avoided.

Description will be made taking an example where 10 mobile terminals N1 to N10 in the data processing system 200 each executes the same or a different app that uses the GPS 304. It is assumed in this case that the power consumption of the GPS 304 at each mobile terminal Ni is 200 [mW] and the power consumption of the communication I/F 306 is 50 [mW].

A use state is assumed where the 10 mobile terminals N1 to N10 operate linked to each other. When each of the mobile terminals N1 to N10 continuously uses the GPS 304 for one hour as in a conventional case, the power consumption of the overall system is, for example, “2,000 [mWh]=200 [mW]×1 [h]×10 [terminal]”.

On the other hand, in the second embodiment, for example, 10 mobile terminals N1 to N10 each execute ad-hoc communication through the communication I/F 306 with the one mobile terminal Ni that has started up the GPS 304 thereof. In this case, the power consumption of the overall system is, for example, “700 [mWh]=200 [mW]×1 [h]×1 [terminal]+50 [mW]×1 [h]×10 [terminal]”.

Therefore, according to the data processing method of the second embodiment, the energy consumption can be reduced by 1,300 [mWh] in the system overall compared to the case where each of the mobile terminals N1 to N10 continuously uses the GPS 304 for one hour.

As described, according to the data processing method and the data processing system of the second embodiment, the power consumption of the overall system can be suppressed and the energy efficiency thereof can be improved when the plural data processing apparatuses execute an app that uses substantially the same peripheral unit.

The mobile terminal Ni according to a third embodiment will be described. Portions identical to the portions described in the first and the second embodiments will be given the same reference numerals used in the first and the second embodiments, and will not be described again.

The applications to be executed by the mobile terminal Ni include those that each has low necessity to be executed concurrently by two or more of the mobile terminals N1 to Nn. For example, for an application causing the mobile terminal Ni to upload information concerning traffic congestion on a road, to the server in a traffic management center, etc., the information concerning the traffic congestion is substantially the same information collected from plural mobile terminals located in the same area. Therefore, most of the information concerning the traffic congestion collected from the plural mobile terminals is not used by the server and thus, this application has low necessity to be executed concurrently by two or more mobile terminals located in the same area.

In the third embodiment, a case will be described where, when an app A that is the same as the app A for which a startup request has been detected by the mobile terminal Ni has been started up by another mobile terminal Nj, the mobile terminal Ni does not start up the app A and thereby, wasteful execution of the app A is suppressed. The functional units of the mobile terminal Ni will be described.

When the startup request for the app A is detected, the determining unit 502 determines whether the app A belongs to a predetermined group. The “predetermined group” is, for example, a set of applications that each has a low necessity to be executed concurrently by two or more of the mobile terminals N1 to Nn. Information to identify the predetermined group is stored in, for example, the memory 301.

If the determining unit 502 determines that the app A belongs to the predetermined group, the transmitting unit 503 transmits a startup check request for the app A to the other mobile terminal Nj. The “startup check request for the app A” is information to ask the other mobile terminal Nj whether the other mobile terminal Nj has started up the app A.

Consequent to the transmission of the startup check request for the app A, the receiving unit 504 receives a startup check response for the app A from the other mobile terminal Nj. The “startup check response for the app A” is information indicating whether the app A has been started up.

The judging unit 505 judges based on the received startup check response for the app A, whether the other mobile terminal Nj has started up the app A. The judgment process executed by the judging unit 505 may be executed based on the startup check response for the app A from the other mobile terminal Nj capable direct communication by ad-hoc communication.

Thereby, the necessity of the execution of the app A can be judged by the mobile terminal Ni, based on the startup check response for the app A from the other mobile terminal Nj located in a vicinity of the mobile terminal Ni, that is, the other mobile terminal Nj that is highly likely to be located in the same area as that of the mobile terminal Ni.

If the judging unit 505 judges that the other mobile terminal Nj has not started up the app A, the assigning unit 507 assigns the app A to any one of the CPUs #1 to #k. As a result, the OS of the assignment destination CPU executes the app A.

If the judging unit 505 judges that the other mobile terminal Nj has started up the app A, the assigning unit 507 does not assign the app A. The app A has been started up by the other mobile terminal Nj and has a low necessity to be executed by the mobile terminal Ni. Therefore, the mobile terminal Ni does not start up the app A.

Thus, the mobile terminal Ni can suppress the execution of the app A, which has a low necessity to be executed concurrently with the other mobile terminal Nj, and the power consumption necessary for the execution of the app A can be reduced.

The receiving unit 504 receives a startup check request for the app A from the other mobile terminal Nj. When the receiving unit 504 receives the startup check request for the app A, the judging unit 505 judges whether the mobile terminal Ni has started up the app A. The transmitting unit 503 transmits to the other mobile terminal Nj that is the request source, a startup check response indicating whether the mobile terminal Ni has started up the app A.

A procedure for data processing by the mobile terminal Ni according to the third embodiment will be described. A procedure will first be described for the data processing of the mobile terminal Ni executed when the mobile terminal Ni detects the startup request for the app A.

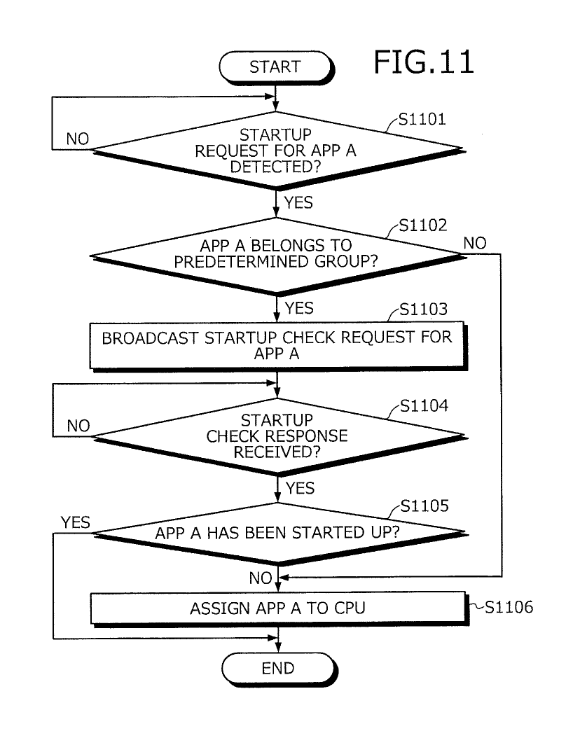

FIG. 11 is a flowchart (Part I) of an example of a procedure for data processing by the mobile terminal according to the third embodiment. In the flowchart of FIG. 11, the scheduler 320 first determines whether a startup request for the app A has been detected (step S1101).

The scheduler 320 waits for a startup request for the app A to be detected (step S1101: NO). When the scheduler 320 determines that a startup request for the app A has been detected (step S1101: YES), the scheduler 320 determines whether the app A belongs to the predetermined group (step S1102).

If the scheduler 320 determines that the app A does not belong to the predetermined group (step S1102: NO), the procedure progresses to step S1106. On the other hand, if the scheduler 320 determines that the app A belongs to the predetermined group (step S1102: YES), the scheduler 320 broadcasts on the network 210, a startup check request for the app A (step S1103).

The scheduler 320 determines whether a startup check response for the app A has been received from the other mobile terminal Nj (step S1104). The scheduler 320 waits for a startup check response for the app A to be received (step S1104: NO). When the scheduler 320 determines that a startup check response for the app A has been received (step S1104: YES), the scheduler 320 determines whether the other mobile terminal Nj has started up the app A (step S1105).

If the scheduler 320 determines that the other mobile terminal Nj has started up the app A (step S1105: YES), the series of process steps according to this flowchart comes to an end. On the other hand, if the scheduler 320 determines that the other mobile terminal Nj has not started up the app A (step S1105: NO), the scheduler 320 assigns the app A to any one among the CPUs #1 to #k (step S1106) and the series of process steps according to this flowchart comes to an end.

Thus, the execution of the app A having a low necessity to be executed concurrently by the other mobile terminal Nj can be suppressed, and the power consumption can be reduced by the amount consumed for the execution of the app A.

A procedure for data processing by the mobile terminal Ni executed when the mobile terminal Ni receives a startup check response for the app A will be described.

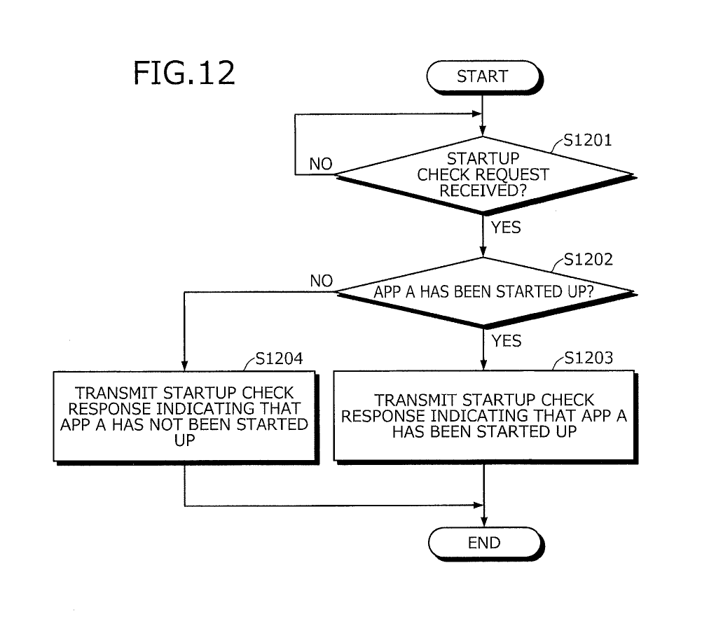

FIG. 12 is a flowchart (Part II) of an example of a procedure for data processing by the mobile terminal according to the third embodiment. In the flowchart of FIG. 12, the scheduler 320 first judges whether a startup check request for the app A has been received from the other mobile terminal Nj (step S1201).

The scheduler 320 waits for a startup check request for the app A to be received (step S1201: NO). When the scheduler 320 judges that a startup check request for the app A has been received (step S1201: YES), the scheduler 320 judges whether the mobile terminal Ni has started up the app A (step S1202).

If the scheduler 320 judges that the mobile terminal Ni has started up the app A (step S1202: YES), the scheduler 320 transmits a startup check response indicating that the app A has been started up, to the other mobile terminal Nj that is the request source (step S1203) and the series of process steps according to this flowchart comes to an end.

On the other hand, if the scheduler 320 judges that the mobile terminal Ni has not started up the app A (step S1202: NO), the scheduler 320 transmits a startup check response indicating that the app A has not been started up, to the other mobile terminal Nj that is the request source (step S1204) and the series of process steps according to this flowchart comes to an end. Thus, the response indicating whether the app A has been started up can be transmitted to the other mobile terminal Nj.

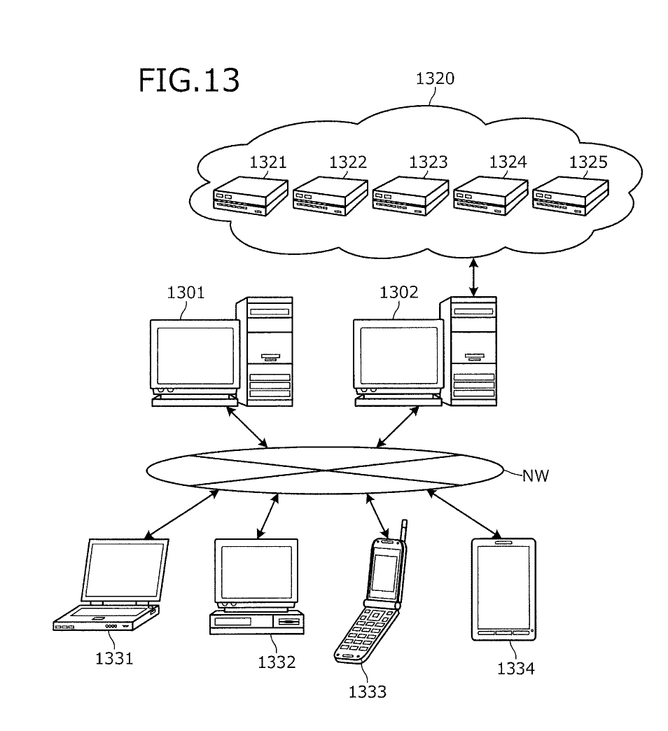

FIG. 13 is a diagram of an example of an application to a system using the computer of the present embodiments. In FIG. 13, a network NW is a network that includes servers 1301 and 1302, and clients 1331 to 1334 that are communicable with each other; and is configured by, for example, a LAN, a WAN, the Internet, or a mobile telephone network.

The server 1302 is a management server of a server group (servers 1321 to 1325) configuring a cloud 1320. Among the clients 1331 to 1334, the client 1331 is a notebook personal computer; the client 1332 is a desktop personal computer; the client 1333 is a mobile telephone (that may be a smartphone or a personal handy-phone system (PHS)); and the client 1334 is a tablet terminal.

The servers 1301, 1302, and 1321 to 1325, and the clients 1331 to 1334 depicted in FIG. 13 are each implemented by, for example, a computer having the same functions as the data processing apparatuses 101 and 102 described in the first embodiment, or having the same functions as the mobile terminal Ni described in the second embodiment.

The data processing method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

An aspect of the embodiments enables overall power consumption to be suppressed in a system that includes plural data processing apparatuses.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing method that is executed by a data processing system, the data processing method comprising:
determining whether an application whose startup is requested by a first data processing apparatus among a plurality of data processing apparatuses, belongs to a predetermined group;
determining whether a second data processing apparatus among the data processing apparatuses has started up the application, when the application belongs to the predetermined group; and
aborting startup of the application by the first data processing apparatus, when the second data processing apparatus has started up the application.

2. The data processing method according to claim 1, wherein
the first data processing apparatus provides a function of the application by communication with the application executed by the second data processing apparatus.

3. The data processing method according to claim 1, wherein
the second data processing apparatus, based on communication from the first data processing apparatus, notifies the first data processing apparatus of whether the second data processing apparatus is currently executing the application.

4. The data processing method according to claim 1, wherein
the first data processing apparatus, when the second data processing apparatus has not started up the application, executes the application and sets a flag indicating that the application has been started up.

5. The data processing method according to claim 1, wherein
the first data processing apparatus executes the application, when the application does not belong to the predetermined group.

6. The data processing method according to claim 5, wherein
the application has an encryption function.

7. The data processing method according to claim 1, wherein
the predetermined group includes an application that is executed by any one among a coprocessor, a digital signal processor, and a global positioning system.

8. The data processing method according to claim 1, wherein
a data processing apparatus other than the second data processing apparatus and among the data processing apparatuses starts up the application, when the second data processing apparatus has started up the application and communication signal strength drops between the first data processing apparatus and the second data processing apparatus.

9. A data processing system comprising:
a plurality of data processing apparatuses that each comprise at least one peripheral unit; and
a scheduler that, when a startup request has been issued for a first peripheral unit of a first data processing apparatus among the data processing apparatuses and a second peripheral unit of a second data processing apparatus among the data processing apparatuses has been started up, causes the second peripheral unit to be shared for execution, without starting up the first peripheral unit.

10. The data processing system according to claim 9, wherein
respective functions of the first peripheral unit and the second peripheral unit are substantially equivalent.

11. The data processing system according to claim 9, wherein
the scheduler executes based on the startup request, broadcast communication with data processing apparatuses among the data processing apparatuses, excluding the first data processing apparatus.

12. The data processing system according to claim 9, wherein
the peripheral unit includes any one among a coprocessor, a digital signal processor, and a global positioning system.
